(19) United States
(12) Patent Application Publication
(10) Pub. No.: US 2020/0302712 A1
(43) Pub. Date: Sep. 24, 2020

(54) VEHICLE DETECTION METHOD, APPARATUS AND VEHICLE DIAGNOSTIC DEVICE

(71) Applicant: AUTEL INTELLIGENT TECHNOLOGY CORP., LTD., Shenzhen (CN)

(72) Inventors: Yuexi YANG, Shenzhen (CN); Zhicong HAN, Shenzhen (CN); Yunyan HUANG, Shenzhen (CN)

(21) Appl. No.: 16/898,658

(22) Filed: Jun. 11, 2020

Related U.S. Application Data
(63) Continuation of application No. PCT/CN2018/119580, filed on Dec. 6, 2018.

(30) Foreign Application Priority Data
Dec. 13, 2017 (CN) 201711332326.4

(51) Int. Cl. G07C 5/08

(52) U.S. Cl. CPC G07C 5/0808

(57) ABSTRACT

Embodiments of the present invention relate to the field of automobile technologies, and disclose a vehicle detection method, apparatus and a vehicle diagnostic device. The vehicle detection method includes: acquiring at least two vehicle identification numbers of a vehicle; comparing the at least two vehicle identification numbers to obtain a comparison result; and generating a detection result according to the comparison result, and outputting the detection result. Through comparison of a plurality of the vehicle identification numbers, consistency of the vehicle identification numbers is detected. Therefore, a user may be helped to determine whether a vehicle is overhauled or a part thereof is replaced.

This application is a continuation application of International Application No. PCT/CN2018/119580, filed on Dec. 6, 2018, which claims priority of Chinese Patent Application No. 201711332326.4, filed on Dec. 13, 2017, which is incorporated herein by reference in its entirety.

### BACKGROUND

### Technical Field

The present application relates to the field of automobile technologies, and in particular, to a vehicle detection method, apparatus and a vehicle diagnostic device.

### Related Art

As people's living standard is increasingly improved, motor vehicles such as an automobile become a very common means of travel. A vehicle may be refit or a part of the vehicle may be replaced for some reason (such as vehicle maintenance). It is very difficult for a non-professional in a vehicle industry to determine whether the vehicle is refit or the part thereof is replaced, and even a professional may not determine whether a part of the vehicle is replaced. Therefore, it is urgent to provide a vehicle detection method to detect consistency of the vehicle to determine whether the vehicle is refit or a part thereof is replaced.

### SUMMARY

The present application provides a vehicle detection method, apparatus and a vehicle diagnostic device that may determine whether a vehicle is refit or a part thereof is replaced.

Embodiments of the present invention disclose technical solutions below.

In a first aspect, an embodiment of the present invention provides a vehicle detection method applied to a vehicle diagnostic device, the method including:

acquiring at least two vehicle identification numbers of a vehicle;

comparing the at least two vehicle identification numbers to obtain a comparison result; and

generating a detection result according to the comparison result, and outputting the detection result.

In some embodiments, the acquiring at least two vehicle identification numbers of a vehicle includes:

acquiring vehicle identification numbers corresponding to electronic control systems from at least two different electronic control systems of the vehicle, respectively.

In some embodiments, the electronic control system includes: any one of an engine control system, a transmission control system, an anti-theft system and a combination instrument system.

In some embodiments, the generating a detection result according to the comparison result includes:

when the vehicle identification numbers acquired from the at least two different electronic control systems are inconsistent, generating a detection result used to represent that there is at least one electronic control system that is inconsistent with other electronic control systems in the vehicle; and

when the vehicle identification numbers acquired from the at least two different electronic control systems are consistent, generating a detection result used to represent that the at least two different electronic control systems are consistent.

In some embodiments, the acquiring at least two vehicle identification numbers of a vehicle includes:

acquiring a vehicle identification number corresponding to an electronic control system from at least one electronic control system of the vehicle, and acquiring a pre-configured vehicle identification number; and

the comparing the at least two vehicle identification numbers to obtain a comparison result includes:

comparing the pre-configured vehicle identification number to a vehicle identification number corresponding to the electronic control system to obtain the comparison result.

In some embodiments, the generating a detection result according to the comparison result includes:

when there is a vehicle identification number that is inconsistent with the pre-configured vehicle identification number in the vehicle identification numbers corresponding to the electronic control system, generating a detection result containing indication information, the indication information being used to indicate an electronic control system corresponding to the vehicle identification number that is inconsistent with the pre-configured vehicle identification number; and

when the vehicle identification numbers corresponding to the electronic control system are all consistent with the pre-configured vehicle identification number, generating a detection result used to represent that the vehicle is normal through detection.

In a second aspect, an embodiment of the present invention provides a vehicle detection apparatus, the apparatus including:

a vehicle identification number acquiring unit configured to acquire at least two vehicle identification numbers of a vehicle;

a comparing unit configured to compare the at least two vehicle identification numbers to obtain a comparison result; and

a detection result outputting unit configured to generate a detection result according to the comparison result, and output the detection result.

In some embodiments, the vehicle identification number acquiring unit is specifically configured to:

acquire vehicle identification numbers corresponding to electronic control systems from at least two different electronic control systems of the vehicle, respectively.

In some embodiments, the detection result outputting unit being configured to generate a detection result according to the comparison result includes:

when the vehicle identification numbers acquired from the at least two different electronic control systems are inconsistent, generating a detection result used to represent that there is at least one electronic control system that is inconsistent with other electronic control systems in the vehicle; and

when the vehicle identification numbers acquired from the at least two different electronic control systems are consistent, generating a detection result used to represent that the at least two different electronic control systems are consistent.

In some embodiments, the vehicle identification number acquiring unit is specifically configured to: acquire a vehicle identification number corresponding to an electronic control system from at least one electronic control system of the vehicle, and acquire a pre-configured vehicle identification number; and

the comparing unit is specifically configured to: compare the pre-configured vehicle identification number to a vehicle identification number corresponding to the electronic control system to obtain the comparison result.

In some embodiments, the detection result outputting unit being configured to generate a detection result according to the comparison result includes:

when there is a vehicle identification number that is inconsistent with the pre-configured vehicle identification number in the vehicle identification numbers corresponding to the electronic control system, generating a detection result containing indication information, the indication information being used to indicate an electronic control system corresponding to the vehicle identification number that is inconsistent with the pre-configured vehicle identification number; and

when the vehicle identification numbers corresponding to the electronic control system are all consistent with the pre-configured vehicle identification number, generating a detection result used to represent that the vehicle is normal through detection.

In a third aspect, an embodiment of the present invention provides a vehicle diagnostic device, including:

at least one processor; and

a memory communicably connected to the at least one processor; wherein

the memory stores an instruction executed by the at least one processor, the instruction being executed by the at least one processor to cause the at least one processor to perform the foregoing vehicle detection method.

In a fourth aspect, an embodiment of the present invention further provides a non-volatile computer readable storage medium, the computer readable storage medium storing a computer executable instruction. When the computer executable instruction is executed by a vehicle diagnostic device, the vehicle diagnostic device is caused to perform the foregoing vehicle detection method.

In a fifth aspect, an embodiment of the present invention provides a computer program product. The computer program product includes a computer program stored on a non-volatile computer readable storage medium. The computer program includes a program instruction. When the program instruction is executed by a vehicle diagnostic device, the vehicle diagnostic device is caused to perform the foregoing vehicle detection method.

In the embodiments of the present invention, a plurality of vehicle identification numbers is compared to detect consistency of the vehicle identification numbers, thereby determining consistency of the vehicle. Through comparison of a plurality of the vehicle identification numbers, consistency of the vehicle identification numbers is detected. Therefore, a user may be helped to determine whether a vehicle is overhauled or a part thereof is replaced.

### BRIEF DESCRIPTION OF THE DRAWINGS

FIG. 1 is a schematic flowchart of a vehicle detection method according to an embodiment of the present invention;

FIG. 2 is a schematic diagram of a vehicle detection apparatus according to an embodiment of the present invention; and

FIG. 3 is a schematic structural diagram of a vehicle diagnostic device according to another embodiment of the present invention.

### DETAILED DESCRIPTION

The technical solutions in the embodiments of the present application will be described clearly and completely below with reference to the drawings in the embodiments of the present application. Obviously, the described embodiments are part of the embodiments of the present application, but not all of the embodiments. Based on the embodiments in the present application, all other embodiments obtained by a person of ordinary skill in the art without creative efforts shall fall within the protection scope of the present application.

In addition, the technical features involved in the various embodiments of the present invention described below can be combined with each other as long as they do not conflict with each other.

First, some terms involved in embodiments of the present application are described.

A vehicle identification number (VIN) is composed of 17-bit bytes and is also called seventeen-bit code. The vehicle identification number is an internationally commonly used code representing a motor vehicle, which is a set of character codes made by a manufacturer for each vehicle, and has unique identification of the vehicle in the world. The vehicle identification number contains information such as a manufacturer, a year, a model, a body type and a code, an engine code and an assembly location of the vehicle. The vehicle model may be identified through the vehicle identification number to facilitate diagnosis and maintenance of the vehicle.

For a vehicle, a plurality of systems configured in the vehicle may include a plurality of vehicle identification numbers, that is, each system includes a vehicle identification number, respectively. A vehicle diagnostic device such as a vehicle diagnostic instrument may obtain the vehicle identification number from one or more systems. For example, several vehicle identification numbers may be acquired from an engine control system, a transmission control system, an anti-theft system or a combination instrument system, etc. of the vehicle. In addition, the several vehicle identification numbers may be further acquired from a pre-configured file or database or through user input.

Because the vehicle identification number is the unique identification of the vehicle, and because sometimes the vehicle is refit or a part thereof is replaced, a plurality of vehicle identification numbers acquired by one or more approaches may not be consistent. Therefore, by determining whether a plurality of the obtained vehicle identification numbers is consistent, the consistency of the vehicles may be detected, that is, it is determined whether the vehicle is refit or the part thereof is replaced.

Embodiments of the present invention provide a vehicle detection method, apparatus and a vehicle diagnostic device to detect whether a vehicle is refit or a part thereof is replaced.

An embodiment of the present application provides a method: first, acquiring at least two vehicle identification numbers; next, comparing the at least two vehicle identification numbers to obtain a comparison result; and finally, generating a detection result according to the comparison result, and outputting the detection result.

Through comparison of a plurality of the obtained vehicle identification numbers, on the one hand, it may be determined whether a body and appearance of the vehicle are the same as a body and appearance of the original vehicle to determine whether the vehicle is refit; on the other hand, it may be determined whether some parts of the vehicle are replaced to help relevant agencies (such as an insurance company, a vehicle administration office, a traffic police team and a used car dealer, etc.) determine whether the vehicle is overhauled or a part thereof is replaced.

Embodiments of the present invention are further described below with reference to drawings.

### Embodiment 1

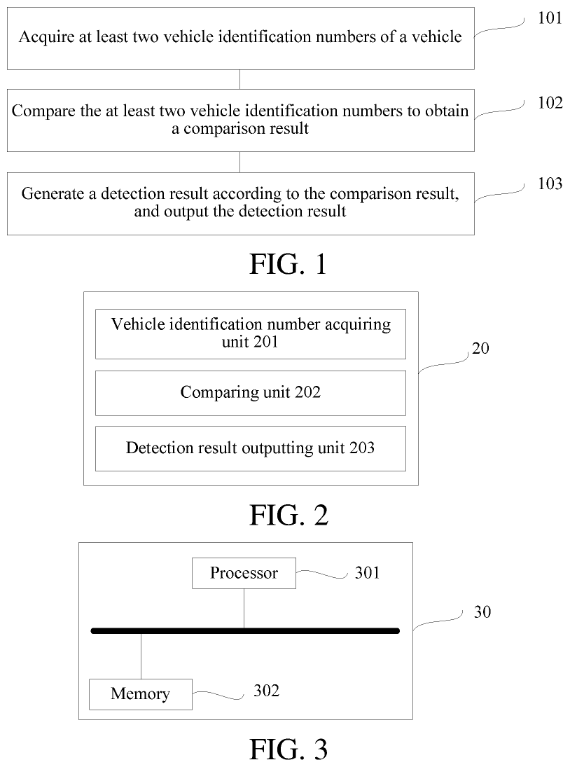

FIG. 1 is a schematic flowchart of a vehicle detection method according to an embodiment of the present invention. A vehicle detection method according to an embodiment of the present invention is applied to a vehicle diagnostic device and the like.

Referring to FIG. 1, the vehicle detection method includes:

101: Acquiring at least two vehicle identification numbers of a vehicle.

In the embodiment of the present invention, the vehicle diagnostic device may acquire at least two vehicle identification numbers of a vehicle by one or more approaches. In particular, the acquiring at least two vehicle identification numbers of a vehicle may include: acquiring vehicle identification numbers corresponding to electronic control systems from at least two different electronic control systems of the vehicle, respectively. The electronic control system includes: an engine control system, a transmission control system, an anti-theft system and a combination instrument system. In some embodiments, the electronic control system may further include other suitable systems, for example, the electronic control system may further include an electronic brake control system and the like.

The acquiring vehicle identification numbers corresponding to electronic control systems from at least two different electronic control systems of the vehicle, respectively includes: sending a vehicle identification number acquiring request to the at least two different electronic control systems; and receiving a vehicle identification number sent according to the vehicle identification number acquiring request from the at least two different electronic control systems.

For example, the vehicle identification number acquiring request is sent to at least two different electronic control systems of the engine control system, the transmission control system, the anti-theft system and the combination instrument system; and vehicle identification numbers sent according to the vehicle identification number acquiring request from at least two different electronic control systems of the engine control system, the transmission control unit, the anti-theft system and the combination instrument system are received.

For example, the vehicle identification number acquiring request may be sent to the engine control system, the transmission control system and the anti-theft system, and after the vehicle identification number acquiring request is sent, the vehicle identification numbers sent according to the vehicle identification number acquiring request from the engine control system, the transmission control system and the anti-theft system are received.

The vehicle identification number acquiring request may be a vehicle identification number acquiring request formed based on a standard instruction of an on-board diagnostic (OBD) system, or a vehicle identification number acquiring request formed based on an instruction customized by a vehicle manufacturer. For example, the vehicle identification number acquiring request formed based on the standard instruction of OBD is sent to the engine control system and the transmission control system. If a vehicle identification number is not received after a preset time, the vehicle identification number acquiring request formed based on the instruction customized by the vehicle manufacturer is sent to the engine control system and the transmission control system so as to acquire vehicle identification numbers from the engine control system and the transmission control system.

In some embodiments, the acquiring at least two vehicle identification numbers of a vehicle may further include: acquiring a vehicle identification number corresponding to an electronic control system from at least one electronic control system of the vehicle, and acquiring a pre-configured vehicle identification number. For example, obtaining a vehicle identification number corresponding to the engine control system from the engine control system, and obtaining a pre-configured vehicle identification number from pre-configured information, so as to obtain at least two vehicle identification numbers of the vehicle.

The acquiring a pre-configured vehicle identification number may include: acquiring a pre-configured vehicle identification number from a preset database or a configuration file. The preset database includes but is not limited to: a database pre-stored in a memory configured for a vehicle diagnostic device, or a database that is accessible on other devices or servers through the network. There may be several preset databases, and each database may store a pre-configured vehicle identification number.

In some embodiments, alternatively, the acquiring a pre-configured vehicle identification number may include: receiving a vehicle identification number inputting instruction, and generating a pre-configured vehicle identification number according to the vehicle identification number inputting instruction; or acquiring the pre-configured vehicle identification number through scanning codes (such as receiving a bar code or a two-dimensional bar code and other types of codes); or acquiring the pre-configured vehicle identification number through image recognition. For example, for acquiring a pre-configured vehicle identification number located on a nameplate of the vehicle, a user may be provided with an interface on which a vehicle identification number may be input, to receive a vehicle identification number inputting instruction, thereby obtaining the pre-configured vehicle identification number located on the nameplate of the vehicle.

It may be understood that, in the embodiment of the present invention, the at least two vehicle identification numbers may only be derived from at least two different electronic control systems of the vehicle. In some embodiments, the at least two vehicle identification numbers may be further partially derived from at least one electronic control system, and partially derived from the pre-configured vehicle identification number. For example, vehicle identification numbers are acquired from the engine control system and the transmission control system of the vehicle, thereby obtaining two vehicle identification numbers. Afterwards, the pre-configured vehicle identification number is acquired from a local database to obtain a pre-configured vehicle identification number. In addition, a vehicle identification number inputting instruction input by a user is received, and the pre-configured vehicle identification number is generated according to the vehicle identification number inputting instruction to obtain a pre-configured vehicle identification number again. That is to say, four vehicle identification numbers are obtained in total.

It may be further understood that a location in which the vehicle identification number is set includes but is not limited to: the engine control system, the transmission control system, the anti-theft system, the combination instrument system, the nameplate and the preset database, etc. At least two vehicle identification numbers of the vehicle may be acquired from different locations by one or more approaches.

102: Comparing the at least two vehicle identification numbers to obtain a comparison result.

Because the vehicle may be refit or a part thereof may be replaced, vehicle identification numbers obtained by one or more approaches may be inconsistent. Therefore, the vehicle diagnostic device may be configured to compare the at least two vehicle identification numbers to obtain the comparison result, thereby determining whether the vehicle identification numbers obtained by one or more approaches are consistent, so as to detect consistency of the vehicle, that is, determining whether the vehicle is refit or the part thereof is replaced.

When the acquiring at least two vehicle identification numbers of a vehicle includes: acquiring a vehicle identification number corresponding to an electronic control system from at least one electronic control system of the vehicle, and acquiring a pre-configured vehicle identification number; the comparing the at least two vehicle identification numbers to obtain a comparison result includes: comparing the pre-configured vehicle identification number to a vehicle identification number corresponding to the electronic control system to obtain the comparison result. Because the pre-configured vehicle identification number is usually not replaced when the vehicle is refit or a part thereof is replaced, the pre-configured vehicle identification number is used as a benchmark for comparison. The pre-configured vehicle identification number is compared to the vehicle identification number corresponding to the electronic control system to obtain the comparison result, so that accuracy of determining whether the vehicle is refit or the part thereof is replaced may be improved.

103: Generating a detection result according to the comparison result, and outputting the detection result.

the generating a detection result according to the comparison result includes: when the vehicle identification numbers acquired from the at least two different electronic control systems are inconsistent, generating a detection result used to represent that there is at least one electronic control system that is inconsistent with other electronic control systems in the vehicle; and when the vehicle identification numbers acquired from the at least two different electronic control systems are consistent, generating a detection result used to represent that the at least two different electronic control systems are consistent. That the electronic control systems are consistent or inconsistent refers to that VINs of the electronic control systems are consistent or inconsistent.

For example, three vehicle identification numbers are acquired from three different electronic control systems, respectively, the three vehicle identification numbers including a “vehicle identification number 1” obtained from the engine control system; a “vehicle identification number 2” obtained from the transmission control system; and a “vehicle identification number 3” obtained from the anti-theft system. If, through comparison of the three vehicle identification numbers, it is obtained that the “vehicle identification number 1” is the same as (consistent with) the “vehicle identification number 2”, and the “vehicle identification number 3” is different from (inconsistent with) the “vehicle identification number 1” and the “vehicle identification number 2”, a detection result used to represent that the anti-theft system is inconsistent with the engine control system and the transmission control system is generated to prompt and guide the user to perform a corresponding operation. In addition, prompting may be performed by a text, a graph and an audio, etc. For example, according to the detection result used to represent that the anti-theft system is inconsistent with the engine control system and the transmission control system, prompting information of a vehicle identification number acquired from the anti-theft system may be displayed and flashed on a user interface, to prompt the user to perform an operation so as to flash the vehicle identification number acquired from the anti-theft system. If, through comparison of the three vehicle identification numbers, it is obtained that the “vehicle identification number 1”, the “vehicle identification number 2” and the “vehicle identification number 3” are the same, a detection result used to represent that the anti-theft system, the engine control system and the transmission control system are consistent is generated.

Definitely, the foregoing detection result is only exemplary, and the embodiment of the present application may further include other detection results, which are not limited herein.

In some embodiments, when a vehicle identification number corresponding to the electronic control system is acquired from at least one electronic control system of the vehicle, and a pre-configured vehicle identification number is acquired, and the pre-configured vehicle identification number is compared to the vehicle identification number corresponding to the electronic control system so as to obtain a comparison result, the generating a detection result according to the comparison result may include: when there is a vehicle identification number that is inconsistent with the pre-configured vehicle identification number in the vehicle identification numbers corresponding to the electronic control system, generating a detection result containing indication information, the indication information being used to indicate an electronic control system corresponding to the vehicle identification number that is inconsistent with the pre-configured vehicle identification number; and when the vehicle identification numbers corresponding to the electronic control system are all consistent with the pre-configured vehicle identification number, generating a detection result used to represent that the vehicle is normal through detection.

For example, obtaining three vehicle identification numbers from the at least two different electronic control systems, and obtaining one pre-configured vehicle identification number. The obtaining three vehicle identification numbers from the at least two different electronic control systems includes obtaining a “vehicle identification number 1” from the engine control system; obtaining a “vehicle identification number 2” from the transmission control system; and obtaining a “vehicle identification number 3” from the anti-theft system. In addition, the pre-configured vehicle identification number is acquired as a “vehicle identification number 4”, and if the pre-configured vehicle identification number is compared to the vehicle identification number corresponding to the electronic control system to obtain that the “vehicle identification number 1” and the “vehicle identification “number 2” are not the same as the “vehicle identification number 4”, and the “vehicle identification number 3” is the same as the “vehicle identification number 4”, a detection result used to represent that the engine control system and the transmission control system are inconsistent with the pre-configured vehicle identification numbers, to prompt and guide the user to perform a corresponding operation. In addition, prompting may be performed by a text, a graph and an audio file, etc. For example, according to the detection result used to represent that the engine control system and the transmission control system are inconsistent with the pre-configured vehicle identification numbers, prompting information of a vehicle identification number acquired from the engine control system and the transmission control system may be displayed and flashed on the user interface, to prompt the user to operate so as to flash the vehicle identification number acquired from the engine control system and the transmission control system. Therefore, the user may send information about flashing the vehicle identification number by means of an external data flashing tool to the vehicle through a communication network (such as a CAN bus), so as to update the vehicle identification numbers stored in the engine control system and the transmission control system. Through the detection information, an inconsistent vehicle identification number may be flashed in time, to facilitate maintenance of vehicle uniformity by a repair factory.

In some embodiments, when there is a vehicle identification number that is inconsistent with the pre-configured vehicle identification number in the vehicle identification numbers corresponding to the electronic control system, prompting information may be further output to prompt and guide the user to perform corresponding maintenance on the vehicle. If the pre-configured vehicle identification number is compared to the vehicle identification number corresponding to the electronic control system to obtain that a “vehicle identification number 1”, a “vehicle identification number 2” and a “vehicle identification number 3” are the same as a “vehicle identification number 4”, a detection result used to represent that the vehicle is normal through detection is generated to indicate that the vehicle is not refit or a part thereof is not replaced.

In an embodiment of the present invention, the outputting the detection result may include, but is not limited to: sending the detection result to an OBD of the vehicle to facilitate maintenance and the like; or sending the detection result to an external device (such as a mobile terminal and a server, etc.), so that the user or some agencies (such as an insurance company, a vehicle administration office, a traffic police team and a used car dealer, etc.) may determine whether the vehicle is refit or overhauled, or a part thereof is replaced, etc.; or outputting the detection result on a user interface, so that the comparison result may be displayed intuitively for the user. The detection result may be output on the user interface in any suitable manner, for example, text, graph, chart, animation, video and audio, etc.

Definitely, the foregoing detection result is only exemplary, and the embodiment of the present application may further include other detection results, which are not limited herein.

In the embodiment of the present invention, a plurality of the obtained vehicle identification numbers is compared to detect consistency of the vehicle identification numbers, thereby determining consistency of the vehicle. Through detection of the consistency of the vehicle, on the one hand, it may be determined whether a body and appearance of the vehicle are the same as a body and appearance of the original vehicle to determine whether the vehicle is refit; on the other hand, it may be determined whether some parts of the vehicle are replaced to help the user or the relevant agencies (such as the insurance company, the vehicle administration office, the traffic police team and the used car dealer, etc.) determine whether the vehicle is overhauled or a part thereof is replaced.

### Embodiment 2

FIG. 2 is a schematic diagram of a vehicle detection apparatus according to an embodiment of the present invention. A vehicle detection apparatus provided according an embodiment of the present invention may be configured in a vehicle diagnostic device.

Referring to FIG. 2, the vehicle detection apparatus 20 includes:

a vehicle identification number acquiring unit 201 configured to acquire at least two vehicle identification numbers of a vehicle.

In the embodiment of the present invention, the vehicle identification number acquiring unit 201 may acquire at least two vehicle identification numbers of the vehicle by one or more approaches. The vehicle identification number acquiring unit 201 may be specifically configured to: acquire vehicle identification numbers corresponding to electronic control systems from at least two different electronic control systems of the vehicle, respectively. The electronic control system includes: an engine control system, a transmission control system, an anti-theft system and a combination instrument system. In some embodiments, the electronic control system may further include other suitable systems, for example, the electronic control system may further include an electronic brake control system and the like.

In particular, the vehicle identification number acquiring unit 201 acquiring vehicle identification numbers corresponding to electronic control systems from at least two different electronic control systems of the vehicle, respectively includes: sending a vehicle identification number acquiring request to the at least two different electronic control systems; and receiving a vehicle identification number sent according to the vehicle identification number acquiring request from the at least two different electronic control systems.

For example, the vehicle identification number acquiring unit 201 sends the vehicle identification number acquiring request to at least two different electronic control systems of the engine control system, the transmission control system, the anti-theft system and the combination instrument system; and receiving vehicle identification numbers sent according to the vehicle identification number acquiring request from at least two different electronic control systems of the engine control system, the transmission control unit, the anti-theft system and the combination instrument system.

In some embodiments, the vehicle identification number acquiring unit 201 may be further configured to: acquire a vehicle identification number corresponding to an electronic control system from at least one electronic control system of the vehicle, and acquire a pre-configured vehicle identification number. For example, obtaining a vehicle identification number corresponding to the engine control system from the engine control system, and obtaining a pre-configured vehicle identification number from pre-configured information, so as to obtain at least two vehicle identification numbers of the vehicle.

The vehicle identification number acquiring unit 201 acquiring a pre-configured vehicle identification number may include: acquiring a pre-configured vehicle identification number from a preset database or a configuration file. The preset database includes but is not limited to: a database pre-stored in a memory configured for a vehicle diagnostic device, or a database that is accessible on other devices or servers through the network. There may be several preset databases, and each database may store a pre-configured vehicle identification number.

In some embodiments, alternatively, the vehicle identification number acquiring unit 201 acquiring a pre-configured vehicle identification number may include: receiving a vehicle identification number inputting instruction, and generating a pre-configured vehicle identification number according to the vehicle identification number inputting instruction; or acquiring the pre-configured vehicle identification number through scanning codes (such as receiving a bar code or a two-dimensional bar code and other types of codes); or acquiring the pre-configured vehicle identification number through image recognition. For example, for acquiring a pre-configured vehicle identification number located on a nameplate of the vehicle, a user may be provided with an interface on which a vehicle identification number may be input, to receive a vehicle identification number inputting instruction, thereby obtaining the pre-configured vehicle identification number located on the nameplate of the vehicle.

It may be understood that, in the embodiment of the present invention, the at least two vehicle identification numbers may only be derived from at least two different electronic control systems of the vehicle. In some embodiments, the at least two vehicle identification numbers may be further partially derived from at least one electronic control system, and partially derived from the pre-configured vehicle identification number.

a comparing unit 202 configured to compare the at least two vehicle identification numbers to obtain a comparison result.

Because the vehicle may be refit or a part thereof may be replaced, vehicle identification numbers obtained from the vehicle identification number acquiring unit 201 by one or more approaches may be inconsistent. Therefore, the comparing unit 202 may be configured to compare the at least two vehicle identification numbers to obtain the comparison result, thereby determining whether the vehicle identification numbers obtained by one or more approaches are consistent, so as to detect consistency of the vehicle, that is, detecting whether the vehicle is refit or the part thereof is replaced.

When the vehicle identification number acquiring unit 201 acquires a vehicle identification number corresponding to an electronic control system from at least one electronic control system of the vehicle, and acquires a pre-configured vehicle identification number; the comparing unit 202 is specifically configured to: compare the pre-configured vehicle identification number to a vehicle identification number corresponding to the electronic control system to obtain the comparison result. Because the pre-configured vehicle identification number is usually not replaced when the vehicle is refit or a part thereof is replaced, the pre-configured vehicle identification number is used as a benchmark for comparison. The pre-configured vehicle identification number is compared to the vehicle identification number corresponding to the electronic control system to obtain the comparison result, so that accuracy of determining whether the vehicle is refit or the part thereof is replaced may be improved.

a detection result outputting unit 203 configured to generate a detection result according to the comparison result, and output the detection result.

The detection result outputting unit 203 being configured to generate a detection result according to the comparison result includes: when the vehicle identification numbers acquired from the at least two different electronic control systems are inconsistent, generating a detection result used to represent that there is at least one electronic control system that is inconsistent with other electronic control systems in the vehicle; and when the vehicle identification numbers acquired from the at least two different electronic control systems are consistent, generating a detection result used to represent that the at least two different electronic control systems are consistent. That the electronic control systems are consistent or inconsistent refers to that VINs of the electronic control systems are consistent or inconsistent.

When the vehicle identification numbers acquired from the at least two different electronic control systems are inconsistent, a detection result used to represent that there is at least one electronic control system that is inconsistent with other electronic control systems in the vehicle is generated through the detection result outputting unit 203, to prompt and guide the user to perform a corresponding operation. In addition, prompting may be performed by a text, a graph and an audio, etc. For example, according to a detection result representing that at least one electronic control system is inconsistent with other electronic control systems in the vehicle, prompting information of a vehicle identification number acquired from an electronic control system that is inconsistent with other electronic control systems may be displayed and flashed on the user interface, to prompt the user to perform an operation so as to flash the vehicle identification number acquired from the electronic control system that is inconsistent with other electronic control systems.

Definitely, the foregoing detection result is only exemplary, and the embodiment of the present application may further include other detection results, which are not limited herein.

In some embodiments, when the vehicle identification number acquiring unit 201 acquires a vehicle identification number corresponding to the electronic control system from at least one electronic control system of the vehicle and acquires a pre-configured vehicle identification number, and the comparing unit 202 compares the pre-configured vehicle identification number to the vehicle identification number corresponding to the electronic control system so as to obtain a comparison result, the detection result outputting unit 203 generating a detection result according to the comparison result includes: when there is a vehicle identification number that is inconsistent with the pre-configured vehicle identification number in the vehicle identification numbers corresponding to the electronic control system, generating a detection result containing indication information, the indication information being used to indicate an electronic control system corresponding to the vehicle identification number that is inconsistent with the pre-configured vehicle identification number; and when the vehicle identification numbers corresponding to the electronic control system are all consistent with the pre-configured vehicle identification number, generating a detection result used to represent that the vehicle is normal through detection. Through the detection information, an inconsistent vehicle identification number may be flashed in time, to facilitate maintenance of vehicle uniformity by a repair factory. In some embodiments, when there is a vehicle identification number that is inconsistent with the pre-configured vehicle identification number in the vehicle identification numbers corresponding to the electronic control system, prompting information may be further output to prompt and guide the user to perform corresponding maintenance on the vehicle.

Definitely, the foregoing detection result is only exemplary, and the embodiment of the present application may further include other detection results, which are not limited herein.

The detection result outputting unit 203 outputting the detection result includes but is not limited to: sending the detection result to an OBD of the vehicle to facilitate maintenance and the like; or sending the detection result to an external device (such as a mobile terminal and a server, etc.), so that the user or some agencies (such as an insurance company, a vehicle administration office, a traffic police team and a used car dealer, etc.) may determine whether the vehicle is refit or overhauled, or a part thereof is replaced, etc.; or outputting the detection result on a user interface, so that the comparison result may be displayed intuitively for the user. The detection result may be output on the user interface in any suitable manner, for example, text, graph, chart, animation, video and audio, etc.

It should be noted that, in the embodiment of the present invention, the vehicle detection apparatus 20 may perform the vehicle detection method provided in Embodiment 1 of the present invention, and has corresponding functional modules to perform the method and beneficial effects thereof. For technical details that are not described in the embodiment of the vehicle detection apparatus 20, reference may be made to the vehicle detection method provided in the Embodiment 1 of the present invention.

### Embodiment 3

FIG. 3 is a schematic structural diagram of hardware of a vehicle diagnostic device according to another embodiment of the present invention. The vehicle diagnostic device includes but is not limited to an automobile diagnostic instrument and a smart terminal, etc. As shown in FIG. 3, the vehicle diagnostic device 30 includes:

one or more processors 301 and a memory 302. In FIG. 3, one processor 301 is taken as an example.

The processor 301 and the memory 302 may be connected through a bus or in other manners. In FIG. 3, the processor and the memory being connected through a bus is used as an example.

The memory 302, as a non-volatile computer readable storage medium, may be used to store a non-volatile software program, a non-volatile computer executable program and unit, such as a program instruction/unit corresponding to the vehicle detection method provided according to the Embodiment 1 of the present invention (for example, the vehicle identification number acquiring unit 201, the comparing unit 202 and the detection result outputting unit 203 shown in FIG. 2). The processor 301 executes various functional applications and data processing of the vehicle diagnostic device by running the non-volatile software program, instruction and unit stored in the memory 302, that is, the vehicle detection method provided in the method embodiment 1 is implemented.

The memory 302 may include a program storage area and a data storage area. The program storage area may store an operating system and an application program that is required for at least one function. The data storage area may store data and the like created according to use of the vehicle diagnostic device. In addition, the memory 302 may include a high-speed random-access memory, and may further include a non-volatile memory, such as at least one magnetic disk storage device, a flash memory device or other non-volatile solid-state storage devices. In some embodiments, the memory 302 may optionally include remotely disposed memories relative to the processor 301, and these remote memories may be connected to a vehicle diagnostic device via a network. Embodiments of the network include but are not limited to, an Internet, an intranet, a local area network, a mobile communication network and a combination thereof.

The one or more units are stored in the memory 302. When the one or more units are executed by one or more processors 301, the vehicle detection method provided in the Embodiment 1 of the present invention is performed, for example, step 101 to step 103 in the foregoing method described in FIG. 1. are performed, or functions of unit 201 to unit 203 in FIG. 2 are achieved.

Exemplarily, the vehicle diagnostic device may further include a communication interface, the communication interface being configured to implement communication of the vehicle with other devices, such as a server. Other apparatuses included in the vehicle diagnostic device are not limited herein.

The vehicle diagnostic device may perform the vehicle detection method provided in the Embodiment 1 of the present invention, and has corresponding functional units to perform the method and beneficial effects thereof. For technical details that are not described in the embodiment of the vehicle diagnostic device, reference may be made to the vehicle detection method provided in the Embodiment 1 of the present invention.

An embodiment of the present invention provides a computer program product. The computer program product includes a computer program stored on a non-volatile computer readable storage medium. The computer program includes a program instruction. When the program instruction is executed by the vehicle diagnostic device, the vehicle diagnostic device is caused to execute the vehicle detection method provided in the Embodiment 1 of the present invention. For example, step 101 to step 103 of the foregoing method described in FIG. 1 is performed, or functions of the unit 201 to unit 203 in FIG. 2 are achieved.

An embodiment of the present invention provides a non-volatile computer readable storage medium. The computer readable storage medium stores a computer executable instruction. The computer executable instruction is used to cause a vehicle diagnostic device to perform the vehicle detection method provided in the Embodiment 1 of the present invention. For example, step 101 to step 103 of the foregoing method described in FIG. 1 is performed, or functions of the unit 201 to unit 203 in FIG. 2 are achieved.

It should be noted that, the apparatus embodiment described above is merely exemplary, and the modules described as separate components may or may not be physically separate, the components displayed as units may or may not be physical units, that is, may be located in one place, or may be distributed on a plurality of network units. Part or all of the modules may be selected according to actual needs to achieve the objective of the solution of this embodiment.

Through the description of the above embodiments, a person skilled in the art can clearly understand that the embodiments can be implemented by means of software plus a general hardware platform, and certainly, can also be implemented by hardware. A person of ordinary skill in the art can understand that all or part of the procedures in the method of the embodiment can be completed by computer program instructions related hardware. The program can be stored in a computer-readable storage medium, and when the program is executed, the procedure of the embodiment of each method may be included. The storage medium may be a magnetic disk, an optical disc, a read-only memory (ROM), or a random access memory (RAM).

Finally, it should be noted that: the above embodiments are only used to describe the technical solution of the present invention, but not limited thereto; under the thought of the present invention, the technical features in the above embodiments or different embodiments may also be combined. The steps can be implemented in any order, and there are many other variations of different aspects of the invention as described above, for brevity, they are not provided in the details; although the present invention is described in detail with reference to the foregoing embodiments, a person of ordinary skill in the art should understand that: it can still modify the technical solutions described in the foregoing embodiments, or equivalently replace some of the technical features; and these modifications or replacements do not deviate the spirit of the corresponding technical solutions from the implementation of the present invention.

What is claimed is:

1. A vehicle detection method applied to a vehicle diagnostic device, wherein the method comprises:
acquiring at least two vehicle identification numbers of a vehicle;
comparing the at least two vehicle identification numbers to obtain a comparison result; and
generating a detection result according to the comparison result, and outputting the detection result.

2. The method according to claim 1, wherein the acquiring at least two vehicle identification numbers of a vehicle comprises:
acquiring vehicle identification numbers corresponding to electronic control systems from at least two different electronic control systems of the vehicle, respectively.

3. The method according to claim 2, wherein the electronic control system comprises: any one of an engine control system, a transmission control system, an anti-theft system and a combination instrument system.

4. The method according to claim 2, wherein the generating a detection result according to the comparison result comprises:
when the vehicle identification numbers acquired from the at least two different electronic control systems are inconsistent, generating a detection result used to represent that there is at least one electronic control system that is inconsistent with other electronic control systems in the vehicle; and
when the vehicle identification numbers acquired from the at least two different electronic control systems are consistent, generating a detection result used to represent that the at least two different electronic control systems are consistent.

5. The method according to claim 1, wherein the acquiring at least two vehicle identification numbers of a vehicle comprises:
acquiring a vehicle identification number corresponding to an electronic control system from at least one electronic control system of the vehicle, and acquiring a pre-configured vehicle identification number; and
the comparing the at least two vehicle identification numbers to obtain a comparison result comprises:
comparing the pre-configured vehicle identification number to a vehicle identification number corresponding to the electronic control system to obtain the comparison result.

6. The method according to claim 5, wherein the generating a detection result according to the comparison result comprises:
when there is a vehicle identification number that is inconsistent with the pre-configured vehicle identification number in the vehicle identification numbers corresponding to the electronic control system, generating a detection result containing indication information, the indication information being used to indicate an electronic control system corresponding to the vehicle identification number that is inconsistent with the pre-configured vehicle identification number; and
when the vehicle identification numbers corresponding to the electronic control system are all consistent with the pre-configured vehicle identification number, generating a detection result used to represent that the vehicle is normal through detection.

7. A vehicle detection apparatus, wherein the apparatus comprises:
a vehicle identification number acquiring unit configured to acquire at least two vehicle identification numbers of a vehicle;
a comparing unit configured to compare the at least two vehicle identification numbers to obtain a comparison result; and
a detection result outputting unit configured to generate a detection result according to the comparison result, and output the detection result.

8. The apparatus according to claim 7, wherein the vehicle identification number acquiring unit is specifically configured to:
acquire vehicle identification numbers corresponding to electronic control systems from at least two different electronic control systems of the vehicle, respectively.

9. The apparatus according to claim 8, wherein the detection result outputting unit being configured to generate a detection result according to the comparison result comprises:
when the vehicle identification numbers acquired from the at least two different electronic control systems are inconsistent, generating a detection result used to represent that there is at least one electronic control system that is inconsistent with other electronic control systems in the vehicle; and
when the vehicle identification numbers acquired from the at least two different electronic control systems are consistent, generating a detection result used to represent that the at least two different electronic control systems are consistent.

10. The apparatus according to claim 7, wherein
the vehicle identification number acquiring unit is specifically configured to: acquire a vehicle identification number corresponding to an electronic control system from at least one electronic control system of the vehicle, and acquire a pre-configured vehicle identification number; and
the comparing unit is specifically configured to: compare the pre-configured vehicle identification number to a vehicle identification number corresponding to the electronic control system to obtain the comparison result.

11. The apparatus according to claim 10, wherein the detection result outputting unit being configured to generate a detection result according to the comparison result comprises:
when there is a vehicle identification number that is inconsistent with the pre-configured vehicle identification number in the vehicle identification numbers corresponding to the electronic control system, generating a detection result containing indication information, the indication information being used to indicate an electronic control system corresponding to the vehicle identification number that is inconsistent with the pre-configured vehicle identification number; and
when the vehicle identification numbers corresponding to the electronic control system are all consistent with the pre-configured vehicle identification number, generating a detection result used to represent that the vehicle is normal through detection.

12. A vehicle diagnostic device, comprising:
at least one processor; and
a memory communicably connected to the at least one processor; wherein
the memory stores an instruction executed by the at least one processor, the instruction being executed by the at least one processor to cause the at least one processor to acquire at least two vehicle identification numbers of a vehicle; compare the at least two vehicle identification numbers to obtain a comparison result; and generate a detection result according to the comparison result, and outputting the detection result.
